(19) United States
(12) Patent Application Publication
(10) Pub. No.: US 2017/0240803 A1
(43) Pub. Date: Aug. 24, 2017

(54) Composition Including Enzymatic Breaker and Activator for Treatment of Subterranean Formations

(71) Applicant: HALLIBURTON ENERGY SERVICES, INC., Houston, TX (US)

(72) Inventors: Prashant D. CHOPADE, Kingwood, TX (US); Baireddy Raghava REDDY, The Woodlands, TX (US); Lucas Kurtis FONTENELLE, Porter, TX (US); Bianca CORIA, Arlington, TX (US)

(73) Assignee: Halliburton Energy Services, Inc., Houston, TX (US)

(21) Appl. No.: 15/507,410

(22) PCT Filed: Dec. 2, 2014
(86) PCT No.: PCT/US2014/068178

§ 371 Date: Feb. 28, 2017

(51) Int. Cl. C09K 8/68; C09K 8/035; E21B 43/26; C09K 8/80; C09K 8/70; C09K 8/90; C09K 8/88

(52) U.S. Cl. CPC C09K 8/685; C09K 8/90; C09K 8/035; C09K 8/887; C09K 8/80; C09K 8/706; E21B 43/26; C09K 2208/24; C09K 2208/26; E21B 43/267

(57) ABSTRACT

Various embodiments disclosed relate to compositions including an enzymatic breaker and an activator for treatment of subterranean formations. In various embodiments, the present invention provides a method of treating a subterranean formation. CThe method includes placing in a subterranean formation a composition including an enzymatic breaker and an enzyme activator including at least one of a) at least one hydroxy group or derivative thereof, and b) at least one sulfonic acid or a salt or ester thereof.

### BACKGROUND

Viscosifiers such as guar gum tend to both initially include and also produce insoluble residue upon breaking (e.g., chemical degradation of the viscosifier). In general, oxidizing agents (e.g., persulfates) or enzymes are used to break the viscosifier, such as by degrading the main polymer backbone of the viscosifier. Breaking of a fracturing fluid is a very important step, as it helps to remove the (formerly) viscous fluid from the proppant pack, leading to increased proppant pack permeability, which in turn benefits the recovery rate of the reservoir.

Enzymatic breakers have been widely used as viscosity breakers in water-based fracturing fluids for more than three decades. Enzymatic breakers have several significant advantages over traditional chemical breakers. First, enzymes are substrate-specific and break long-chain polymers at specific sites without causing undesirable reactions in the wellbore, in the formation, or on the fracturing equipment. Second, due to the catalytic nature of enzymes, they are not consumed, thereby requiring a minimal amount. Third, enzymes are non-toxic compared to oxidant breakers. However, enzymes operate under a narrow pH range and their functional states are often inactivated at high pH values. In addition, at elevated temperatures, enzyme activity decreases or completely diminishes due to denaturing. Conventional enzymatic breakers are most effective at lower temperatures (<140° F.) and at pH 3.5-8.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

FIG. 3 illustrates viscosity and temperature for various samples, in accordance with various embodiments.

FIG. 4 illustrates viscosity and temperature versus time for various samples, in accordance with various embodiments.

FIG. 5 illustrates viscosity and temperature versus time for various samples, in accordance with various embodiments.

FIG. 6 illustrates viscosity and temperature versus time for various samples, in accordance with various embodiments.

FIG. 7 illustrates viscosity and temperature versus time for various samples, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.”

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000.1” is equivalent to “0.0001.”

In the methods of manufacturing described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, within 1%, or within 0% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(=NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can itself be substituted or unsubstituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(=NH)N(R)₂, C(O)N(OR)R, and C(=NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, or 5-substituted phenyl or 2-7 substituted naphthyl groups, which can be substituted with carbon or non-carbon groups such as those listed herein.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Non-limiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having n₁ molecules of molecular weight M₁ through the formula Mₙ=ΣM₁n₁/Σn₁. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣM₁²nᵢ/ΣM₁n₁, where n₁ is the number of molecules of molecular weight M₁. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit (e.g., monomer) and can include copolymers and oligomers.

The term “copolymer” as used herein refers to a polymer that includes at least two different repeating units. A copolymer can include any suitable number of repeating units.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packer fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of a composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

As used herein, “pptg” refers to pounds per thousand gallons.

As used herein, “gptg” refers to gallons per thousand gallons.

In various embodiments, the present invention provides a method of treating a subterranean formation. The method includes placing a composition in a subterranean formation. The composition includes an enzymatic breaker. The composition also includes an enzyme activator. The enzyme activator includes a phenyl propane unit that includes at least one of a) at least one hydroxy group or derivative thereof, and b) at least one sulfonic acid or a salt or ester thereof.

In various embodiments, the present invention provides a method of treating a subterranean formation. The method includes placing in a subterranean formation a composition including an enzymatic breaker including at least one of hemicellulase and beta-glycosidase. The composition also includes at least one of a lignosulfonic acid salt and a lignin.

In various embodiments, the present invention provides a system including a composition including an enzymatic breaker and an enzyme activator including at least one of a) at least one hydroxy group or derivative thereof, and b) at least one sulfonic acid or a salt or ester thereof. The system also includes a subterranean formation including the composition therein.

In various embodiments, the present invention provides a composition for treatment of a subterranean formation. The composition includes an enzymatic breaker and an enzyme activator including a phenyl propane unit including at least one of a) at least one hydroxy group or derivative thereof, and b) at least one sulfonic acid or a salt or ester thereof.

In various embodiments, the present invention provides a composition for treatment of a subterranean formation. The composition includes an enzymatic breaker including at least one of hemicellulase and beta-glycosidase. The composition also includes at least one of a lignosulfonic acid salt and a lignin.

In various embodiments, the present invention provides a method of preparing a composition for treatment of a subterranean formation. The method includes forming a composition that includes an enzymatic breaker and an enzyme activator including at least one of a) at least one hydroxy group or derivative thereof, and b) at least one sulfonic acid or a salt or ester thereof.

In general, controlling break times of fracturing fluids can be challenging. Usually, customizable break times are obtained by varying the concentration of the breaker. For example, if faster break time is needed, then a higher breaker amount is added to the fluid. However, the use of higher amounts of breaker for a faster fluid break can add significant cost to the fluid design. Conversely, if a lesser amount of enzyme is used, extended break times are achievable, but incomplete polymer breakdown may result, potentially leading to greater formation damage, lower proppant pack permeability, and underperforming reservoir conductivity. Maintaining the economics of well construction is of utmost concern for many operators, and increasing the performance of fracturing fluids while maintaining the cost can be beneficial.

Various embodiments of the present composition and method of using the same have certain advantages over other breaker compositions and methods of using the same, at least some of which are unexpected. In various embodiments, the enzyme activator can allow the enzymatic breaker to effectively break down viscosifiers at higher temperatures (e.g., up to 140° F., up to 160° F., or about 115° F. to about 300° F., about 130° F. to about 200° F., or about 140° F. to about 160° F., or about 100° F. or less, or about 105° F., 110, 115, 120, 125, 130, 135, 140, 142, 144, 146, 148, 150, 152, 154, 156, 158, 160, 165, 170, 175, 180, 185, 190, 200, 220, 240, 260, 280, 300, 320, 340, 360, 380, or about 400° F. or more) than possible without the enzyme activator. In various embodiments, the enzyme activator can allow the enzymatic breaker to effectively break down viscosifiers at higher pH levels (e.g., up to 10.5 pH, or higher) than possible without the enzyme activator. In various embodiments, the combination of the enzyme activator and the enzymatic breaker can break viscosified compositions at least one of more quickly and more completely than corresponding enzymatic breaker compositions that lack the enzyme activator. In various embodiments, the more complete breaking enabled by the combination of the enzymatic breaker and the enzyme activator leads to less viscosifier residue left behind in the formation and higher regain permeability (e.g., less formation damage, which results in better production rates). In various embodiments, the enzymatic breaker and the enzyme activator can be pre-mixed prior to contacting the polymeric viscosifier. In various embodiments, premixing can have benefits such as no mixing being required at the drilling site, thereby making the composition simple and convenient to use.

In various embodiments, a composition including the enzymatic breaker and the enzyme activator can produce a given degree of breaking (e.g., viscosity reduction) using less enzymatic breaker than with a corresponding enzymatic breaker composition that lacks the enzyme activator. In various embodiments, the more effective and more efficient breaking of the composition can allow less of the expensive enzymatic breaker to be used due to the presence of the inexpensive and readily available enzyme activator, thereby reducing costs. In various embodiments, despite use of a smaller amount of enzymatic breaker, the resulting breakdown of the viscosifier can be more complete due to the presence of the enzyme activator as compared to other compositions including a greater amount of enzymatic breaker.

In various embodiments, by varying the amount of enzyme activator, the break times can be conveniently modulated. In various embodiments, the enzymatic breaker can be combined with a small amount of enzyme activator for delayed breaking that gives a more complete polymer breakdown than breaker compositions that merely modulate the amount of breaker. Thus, in various embodiments, the present invention can provide more complete fracturing fluid deviscosification, better regained permeability, and better reservoir productivity.

### Method of Treating a Subterranean Formation.

In various embodiments, the present invention provides a method of treating a subterranean formation. The method includes placing in a subterranean formation a composition including an enzymatic breaker and an enzyme activator including a phenyl propane unit including at least one of a) at least one hydroxy group or derivative thereof, and b) at least one sulfonic acid or a salt or ester thereof. The combination of the enzyme activator can allow the enzymatic breaker to break down a polymeric viscosifier with at least one of higher temperature conditions, higher pH conditions, less enzymatic breaker, more complete breakdown, faster breakdown, and more easily controlled (time and intensity) break down. In some embodiments, the method includes using the combination of the enzymatic breaker and the enzyme activator to break down polymeric viscosifiers used during a hydraulic fracturing operation to restore permeability to the subterranean formation. In other embodiments, the method includes using the enzymatic breaker and the enzyme activator to break down a polymeric viscosifier during any suitable subterranean treatment. In some embodiments, the method of treating the subterranean formation can be a method of drilling, stimulation, fracturing, spotting, clean-up, completion, remedial treatment, applying a pill, acidizing, cementing, packing, spotting, or a combination thereof.

The method includes placing the composition in a subterranean formation. The placing of the composition in the subterranean formation can include contacting the composition and any suitable part of the subterranean formation, or contacting the composition and a subterranean material, such as any suitable subterranean material. The subterranean formation can be any suitable subterranean formation (e.g., traversed by a wellbore).

In some embodiments, the composition can be placed in the subterranean formation such that the composition encounters a polymeric viscosifier downhole, and the enzymatic breaker can break down the viscosifier. In other embodiments, a polymeric viscosifier can be included in the composition, and the enzymatic breaker can break down the viscosifier when desired. In some embodiments, the composition can be diluted when placed downhole, such that the working concentration of the components (e.g., the concentration at which the enzymatic breaker and polymer activator are designed to break down the viscosifier) is lower than the concentration of the components when originally placed in the subterranean formation. In some embodiments, the composition can be placed downhole with concentrations of the enzymatic breaker and the enzyme activator that is similar to or the same as the intended working concentrations of the enzymatic breaker and the enzyme activator.

In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include at least partially depositing the composition in a fracture, flow pathway, or area surrounding the same.

In some embodiments, the method includes obtaining or providing the composition including the enzymatic breaker and the enzyme activator. The obtaining or providing of the composition can occur at any suitable time and at any suitable location. The obtaining or providing of the composition can occur above the surface. For example, the enzyme activator, the enzymatic breaker, and any other components of the composition can be mixed together at the surface to provide the composition, and the composition can be subsequently placed in the subterranean formation. In another embodiment, the obtaining or providing of the composition can occur in the subterranean formation (e.g., downhole). For example, the enzyme activator can be placed in the subterranean formation to combine with an enzymatic breaker that is already in the subterranean formation to form the composition in the subterranean formation. In another example, the enzymatic breaker can be placed in the subterranean formation to combine with an enzyme activator that is already in the subterranean formation to form the composition in the subterranean formation. In another example, a mixture of the enzymatic breaker and the enzyme activator can be placed downhole to combine with a viscosified mixture to form the composition in the subterranean formation, and the enzymatic breaker and enzyme activator can then break down the polymeric viscosifier (optionally with some time delay). In an embodiment, the enzymatic breaker and enzyme activator can be pre-mixed and stored in a concentrated form for any suitable time period, such as for at least 24 hours, followed by dilution to a required concentration to provide the breaker composition. In some embodiments, the composition including the enzymatic breaker and enzyme activator can be the pre-mixed composition. In some embodiments, the composition including the enzymatic breaker and enzyme activator can be the diluted pre-mixed composition in a form ready to be used for breaking.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed in or contacted to, or the composition is placed in or contacted to an area surrounding the generated fracture or flow pathway.

In some embodiments, in addition to the enzymatic breaker and the enzyme activator, the composition can include at least one of an aqueous liquid and a water-miscible liquid. The method can further include mixing the aqueous liquid or water-miscible liquid with the enzymatic breaker or the enzyme activator. The mixing can occur at any suitable time and at any suitable location, such as above surface or in the subterranean formation. The aqueous liquid can be any suitable aqueous liquid, such as at least one of water, brine, produced water, flowback water, brackish water, and sea water. In some embodiments, the aqueous liquid can include at least one of a drilling fluid, a hydraulic fracturing fluid, a diverting fluid, and a lost circulation treatment fluid. The water-miscible liquid can be any suitable water-miscible liquid, such as methanol, ethanol, ethylene glycol, propylene glycol, glycerol, and the like.

The composition can include any suitable proportion of the aqueous liquid or the water-miscible liquid, such that the composition can be used as described herein. For example, about 0.000.1 wt % to 99.999.9 wt % of the composition can be the aqueous liquid, water-miscible liquid, or combination thereof, or about 0.01 wt % to about 99.99 wt %, about 0.1 wt % to about 99.9 wt %, or about 20 wt % to about 90 wt %, or about 0.000,1 wt % or less, or about 0.000.001 wt %, 0.000.1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999 wt %, or about 99.999.9 wt % or more of the composition can be the aqueous liquid, water-miscible liquid, or combination thereof.

The aqueous liquid can be a salt water. The salt can be any suitable salt, such as at least one of NaBr, CaCl₂, CaBr₂, ZnBr₂, KCl, NaCl, a magnesium salt, a bromide salt, a formate salt, an acetate salt, and a nitrate salt.

The aqueous liquid can have any suitable total dissolved solids level, such as about 1,000 mg/L to about 250,000 mg/L, or about 1,000 mg/L or less, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The aqueous liquid can have any suitable salt concentration, such as about 1,000 ppm to about 300,000 ppm, or about 1,000 ppm to about 150,000 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, or about 300,000 ppm or more. In some examples, the aqueous liquid can have a concentration of at least one of NaBr, CaCl₂, CaBr₂, ZnBr₂, KCl, and NaCl of about 0.1% w/v to about 20% w/v, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more.

In some embodiments, a borate-crosslinked guar solution including about 0.15 gptg of the enzymatic breaker and about 1 pptg of the enzyme activator under conditions including about 30 minutes at about 100° F. to about 400° F. (e.g., about 115° F. to about 300° F., about 130° F. to about 200° F., or about 140° F. to about 160° F., or about 100° F. or less, or about 105° F., 110, 115, 120, 125, 130, 135, 140, 142, 144, 146, 148, 150, 152, 154, 156, 158, 160, 165, 170, 175, 180, 185, 190, 200, 220, 240, 260, 280, 300, 320, 340, 360, 380, or about 400° F. or more) and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

In some embodiments, a borate-crosslinked guar solution including about 0.15 gptg of the enzymatic breaker and about 1 pptg of the enzyme activator under conditions including about 30 minutes at about 140° F. to 160° F. and a shear rate of 40 s⁻¹ with a pH of about 2 to about 14 (e.g., about 3 to about 13, about 4 to about 12, or about 2 or less, or about 2.5, 3, 3.5, 4, 4.5, 5, 5.5, 6, 6.5, 7, 7.5, 8, 8.5, 9, 9.5, 10, 10.1, 10.2, 10.3, 10.4, 10.5, 10.6, 10.7, 10.8, 10.9, 11, 11.2, 11.4, 11.6, 11.8, 12, 12.2, 12.4, 12.6, 12.8, 13, 13.5, or about 14 or more) has a viscosity of less than about 200 cP, wherein a corresponding borate-crosslinked guar solution that is free of the enzyme activator has a viscosity of about 500 cP to about 2000 cP under the same conditions.

In some embodiments, a borate-crosslinked guar solution including about 0.1 gptg of the enzymatic breaker and about 0.5 pptg of the enzyme activator under conditions including about 80 minutes at about 140° F. to about 160° F. and a shear rate of 40 s⁻¹ with a pH of 10.5 has a viscosity of greater than about 500 cP, and under conditions including about 120 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions. In some embodiments, a borate-crosslinked guar solution including about 0.1 gptg of the enzymatic breaker and about 0.1 pptg of the enzyme activator under conditions including about 60 minutes at about 140° F. to about 160° F. and a shear rate of 40 s⁻¹ with a pH of 10.5 has a viscosity of greater than about 500 cP, and under conditions including about 100 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

In some embodiments, a borate-crosslinked guar solution including about 0.15 gptg to about 0.2 gptg of the enzymatic breaker and about 1 pptg of the enzyme activator under conditions including about 60 minutes at about 140° F. to about 160° F. provides a percent regain permeability (e.g., percent of original permeability that is regained after treatment) in a core having an initial permeability of about 1 md to about 150 md (e.g., about 5 md to about 90 md, or about 1 md or less, or about 5 md, 10, 20, 30, 40, 50, 60, 70, 80, 90, 100, 110, 120, 130, 140, or about 150 md or more) that is about 1% to about 20% higher (e.g., about 4% to about 10% higher, or about 1% higher or less, or about 2%, 3, 4, 5, 6, 7, 8, 9, 10, 11, 12, 13, 14, 15, 16, 17, 18, 19, or about 20% or more higher) than the percent regain permeability of a corresponding borate-crosslinked guar solution that is free of the enzyme activator.

In some embodiments, the enzymatic breaker, the polymeric breaker, or both, can be encapsulated or otherwise formulated to give a delayed-release or a time-release of the breaker, such that the surrounding liquid can remain viscous for a suitable amount of time prior to breaking. In some embodiments, the enzyme activator, the enzymatic breaker, or both, can be used in a lower concentration to induce a time delay.

### Enzymatic Breaker.

The composition includes a least one enzymatic breaker. The composition can include one enzymatic breaker, or the composition can include multiple enzymatic breakers. The enzymatic breaker can break down a polymeric viscosifier, such as in the presence of the enzyme activator. The composition can have any suitable concentration of the enzymatic breaker, such that the composition can be used as described herein. For example, about 0.001 gptg to about 999 gptg of the composition can be the enzymatic breaker, 0.001 gptg to about 50 gptg, about 0.01 gptg to about 1 gptg, about 0.1 gptg to about 0.2 gptg, or about 0.001 gptg or less, or about 0.005, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.22, 0.24, 0.26, 0.28, 0.3, 0.35, 0.4, 0.45, 0.5, 0.6, 0.7, 0.8, 0.9, 1, 1.5, 2, 2.5, 3, 3.5, 4, 4.5, 5, 6, 7, 8, 9, 10, 15, 20, 25, 30, 35, 40, 45, 50, 75, 100, 150, 200, 250, 500, 750, or about 999 gptg of the composition or more. The enzymatic breaker can be available as a powder, as a solution (e.g., aqueous solution), or as a suspension.

The enzymatic breaker can be at least one of an alpha or beta amylase, amyloglucosidase, oligoglucosidase, invertase, maltase, mannanase, galactomannanase, glycocidase, cellulase, hemi-cellulase, and mannanohydrolase. The enzymatic breaker can be at least one of a deaminase, a dehydrogenase, an oxidase, a reductase, a phosphorylase, an aldolase, a synthetase, a hydrolase, and a hydroxyethylphosphonate dioxygenase. The enzymatic breaker can be at least one of a hemicellulase, a mannanase, a xylanase, and a glycosidase. The enzymatic breaker can be at least one of beta-glycosidase, beta-D-mannoside mannohydrolase, and mannan endo-1,4-beta-mannosidase.

### Enzyme Activator.

The composition can include at least one enzyme activator including a phenyl propane unit including at least one of a) at least one hydroxy group or derivative thereof, and b) at least one sulfonic acid or a salt or ester thereof. In some embodiments, the enzyme activator includes a phenyl propane unit including at least one sulfonic acid or a salt or ester thereof. In some embodiments, the enzyme activator includes a phenyl propane unit include at least one hydroxy group or derivative thereof. In some embodiments, the enzyme activator includes a phenyl propane unit including both at least one hydroxy group or derivative thereof and a sulfonic acid or a salt or ester thereof. In various embodiments, the enzyme activator can be an enzyme stabilizer that can stabilize the enzyme breaker under various conditions. The ester can be an alkyl ester, such as a (C₁-C₅)alkyl ester. The hydroxy group derivative can be any suitable hydroxy group derivative, such as an ether or an ester derived from reaction with a (C₁-C₅₀)alkanoic acid. In some embodiments, the phenyl propane unit can be a repeating unit of a polymer (e.g., the enzyme activator can be a polymeric activator), wherein the phenyl propane repeating unit can include any suitable number of intermolecular bonds (e.g., bonds to other repeating units), such as 1 (-yl), 2 (-ylene), 3 (-triyl), or more. In some embodiments, the phenyl propane unit is included in the structure of the enzyme activator which can be non-polymeric or polymeric. The composition can include one enzyme activator or more than one enzyme activator. The enzyme activator can activate the enzymatic breaker, allowing the breaker to break down a polymeric viscosifier. The activator can cause the enzymatic breaker to break down the polymeric viscosifier more quickly or more completely than the enzymatic breaker without the activator.

The composition can include any suitable amount of the enzyme activator, such that the composition can be used as described herein. In some embodiments, the composition can be designed to be placed downhole at a high concentration and diluted to an intended working concentration downhole in the presence of a viscosifier. In some embodiments, the composition can be placed downhole at a similar concentration as an intended working concentration for breaking a viscosifier. In some embodiments, about 0.001 pptg to about 8339 pptg of the composition can be the one or more enzyme activators, about 0.001 pptg to about 400 pptg, about 0.01 pptg to about 5 pptg, about 0.1 to about 1 pptg, or about 0.001 pptg or less, or about 0.005 pptg, 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.8, 2, 2.5, 3, 3.5, 4, 4.5, 5, 6, 7, 8, 9, 10, 15, 20, 25, 30, 35, 40, 45, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 450, 500, 750, 1,000, 2,000, 5,000, or about 8339 pptg or more of the composition.

The sulfonic acid of the enzyme activator can be in the form of a salt. The sulfonate ion in the salt can have any suitable counterion, such as a counterion that is independently chosen from Na⁺, K⁺, Li⁺, Zn⁺, NH₄⁺, Fe²⁺, Fe³⁺, Cu³⁺, Cu²⁺, Ca²⁺, Mg²⁺, Zn²⁺, and an Al³⁺. The sulfonic acid of the enzyme activator can be in the form of a (C₁-C₅)alkyl ester thereof (e.g., a methyl, ethyl, propyl (e.g., iso- or normal-), butyl (e.g., tert-, normal-, or iso-) ester).

The enzyme activator can be a lignosulfonic acid, or a salt thereof (e.g., a lignosulfonate), or an ester thereof (e.g., an alkyl ester, such as a (C₁-C₅)alkyl ester). Each phenyl propane unit in the polymer can include any suitable number of sulfonic acid groups (or salts or esters thereof), such as about 0.001 sulfonic acid group per unit to about 5 sulfonic acid group per unit, or about 0.01 to about 3, or about 0.001 or less, or about 0.005, 0.01, 0.05, 0.1, 0.5, 1, 1.5, 2, 2.5, 3, 3.5, 4, 4.5, or about 5 sulfonic acids groups per unit. Lignosulfonic acids, salts thereof, and esters thereof can be recovered from the spent pulping liquids from sulfite pulping. The Howard process can be used to generate the lignosulfonic acids and derivatives thereof, by precipitating calcium lignosulfonates by addition of excess calcium hydroxide. Filtration or ion-exchange can be used to separate lignosulfonic acids and derivatives thereof from a spend pulping liquid. The enzyme activator can be a lignosulfonic acid salt (e.g., a lignosulfonate). The enzyme activator can be a sulfonated Kraft lignin. The enzyme activator can be a lignosulfonic acid salt prepared via the Howard process, or via any suitable process.

The enzyme activator can have any suitable molecular weight. For example, the enzyme activator can have a molecular weight of about 1,000 g/mol to about 500,000 g/mol, about 1,000 g/mol to about 200,000 g/mol, 1,000 g/mol to about 140,000 g/mol, about 5,000 g/mol to about 50,000 g/mol, 5,000 g/mol to about 8,000 g/mol, or about 1,000 g/mol or less, or about 2,000 g/mol, 5,000, 10,000, 15,000, 20,000, 25,000, 30,000, 40,000, 50,000, 60,000, 70,000, 80,000, 90,000, 100,000, 110,000, 120,000, 130,000, 140,000, 150,000, 175,000, 200,000, 300,000, 400,000, or about 500,000 g/mol or more.

In some embodiments, the phenyl propane unit in the enzyme activator can be a phenyl propane repeating unit having the structure:

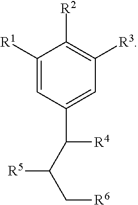

The repeating unit in the enzyme activator can be independently selected at each occurrence. In some embodiments, the enzyme activator can only include the R¹-R⁶-containing structure in this paragraph, while in other embodiments the enzyme activator can include other repeating units not shown. At each occurrence R¹, R³, R⁴, and R⁵ can be each independently chosen from —H, R², and R⁶. At each occurrence R² and R⁶ can be each independently chosen from —OH, —OCH₃, —O-Q, -Q, and —S(O)(O)(OH) or a salt or (C₁-C₅)alkyl ester thereof. At each occurrence Q can be independently chosen from the same or different phenyl propane repeating unit bound via position R¹, R², R³, R⁴, R⁵, or R⁶, and a different repeating unit. Any one or more of R¹, R², R³, R⁴, R⁵, or R⁶ in a particular unit can be —S(O)(O)(OH) or a salt or (C₁-C₅)alkyl ester thereof. In some embodiments, at least one of R¹, R², and R³ in a particular unit can be —S(O)(O)(OH) or a salt or (C₁-C₅)alkyl ester thereof. The enzyme activator can have at least some phenyl propane repeating units with R⁴ of —S(O)(O)(OH) or a salt or (C₁-C₅)alkyl ester thereof. The enzyme activator can have at least some phenyl propane repeating units with R⁴ of —S(O)(O)(OH) or a salt or (C₁-C₅)alkyl ester thereof. In various embodiments, the unsubstituted sites on the phenyl ring can be substituted with sulfonic acid or a salt or (C₁-C₅)alkyl ester thereof, or sulfomethylated groups in the form of the sulfonic acid or a salt or (C₁-C₅)alkyl ester thereof.

Other Components.

The composition including the enzymatic breaker and enzyme activator, or a mixture including the composition, can include any suitable additional component in any suitable proportion, such that the enzymatic breaker and enzyme activator, composition, or mixture including the same, can be used as described herein.

In some embodiments, the composition includes one or more viscosifiers. The viscosifier can be any suitable viscosifier. The viscosifier can affect the viscosity of the composition or a solvent that contacts the composition at any suitable time and location. In some embodiments, the viscosifier is a polymeric viscosifier. In some embodiments, the viscosifier provides an increased viscosity at least one of before injection into the subterranean formation, at the time of injection into the subterranean formation, during travel through a tubular disposed in a borehole, once the composition reaches a particular subterranean location, or some period of time after the composition reaches a particular subterranean location. In some embodiments, the viscosifier can be about 0.000,1 wt % to about 10 wt % of the composition or a mixture including the same, about 0.004 wt % to about 0.01 wt %, or about 0.000,1 wt % or less, 0.000,5 wt %, 0.001, 0.005, 0.01, 0.05, 0.1, 0.5, 1, 2, 3, 4, 5, 6, 7, 8, 9, or about 10 wt % or more of the composition or a mixture including the same.

The polymeric viscosifier can include at least one of a substituted or unsubstituted polysaccharide, and a substituted or unsubstituted polyalkene (e.g., a polyethylene, wherein the ethylene unit can be substituted, such as to improve water-solubility), and can be derived from the corresponding substituted or unsubstituted ethene), wherein the polysaccharide or polyalkene is crosslinked or uncrosslinked. The viscosifier can include a polymer including at least one repeating unit derived from a monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and a poly((C₂-C₁₀)alkene), wherein the (C₂-C₁₀)alkene is substituted or unsubstituted (e.g., the (C₂-C₁₀)alkene unit can be substituted, such as to improve water-solubility). The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum (e.g., hydroxypropyl guar, carboxy methyl guar, or carboxymethyl hydroxypropyl guar), gum ghatti, gum arabic, locust bean gum, cellulose, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂o)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N-(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include one or more crosslinkers. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the crosslinker can be a (C₁-C₂₀)alkylenebiacrylamide (e.g., methylenebisacrylamide), a poly((C₁-C₂₀)alkenyl)-substituted mono- or poly-(C₁-C₂o)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The crosslinker can be about 0.000,01 wt % to about 5 wt % of the composition or a mixture including the same, about 0.001 wt % to about 0.01 wt %, or about 0.000,01 wt % or less, or about 0.000,05 wt %, 0.000,1, 0.000,5, 0.001, 0.005, 0.01, 0.05, 0.1, 0.5, 1, 2, 3, 4, or about 5 wt % or more.

In some embodiments, the composition can include one or more secondary breakers. The secondary breaker can be any suitable breaker, such that the viscosity of the treatment fluid or the fluid surrounding the composition (e.g., a fracturing fluid) can be at least partially broken for more complete and more efficient recovery thereof, such as at the conclusion of the hydraulic fracturing treatment. In some embodiments, the secondary breaker can be encapsulated or otherwise formulated to give a delayed-release or a time-release of the breaker, such that the treatment fluid or the fluid surrounding the composition can remain viscous for a suitable amount of time prior to breaking. The secondary breaker can be any suitable breaker; for example, the breaker can be a compound that includes at least one of a Na⁺, K⁺, Li⁺, Zn⁺, NH₄⁺, Fe²⁺, Fe³⁺, Cu¹⁺, Cu²⁺, Ca²⁺, Mg²⁺, Zn³⁺, and an Al³⁺ salt of a chloride, fluoride, bromide, phosphate, or sulfate ion. In some examples, the secondary breaker can be an oxidative breaker or an enzymatic breaker. An oxidative breaker can be at least one of a Na⁺, K⁺, Li⁺, Zn⁺, NH⁴⁺, Fe²⁺, Fe³⁺, Cu³⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyporchlorite ion. A secondary enzymatic breaker can be any suitable enzymatic breaker described herein, such as at least one of an alpha or beta amylase, amyloglucosidase, oligoglucosidase, invertase, maltase, cellulase, hemi-cellulase, and mannanohydrolase. The secondary breaker can be about 0.000,1 wt % to about 30 wt % of the composition or a mixture including the same, about 0.000,1 wt % to about 10 wt %, or about 0.01 wt % to about 5 wt %, or about 0.000,1 wt % or less, or about 0.000,5 wt %, 0.001, 0.005, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of the composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the enzymatic breaker and enzyme activator or a mixture including the same can include any suitable downhole fluid. The composition including the enzymatic breaker and enzyme activator can be combined with any suitable downhole fluid before, during, or after the placement of the composition in the subterranean formation or the contacting of the composition and the subterranean material. In some examples, the composition including the enzymatic breaker and enzyme activator is combined with a downhole fluid above the surface, and then the combined composition is placed in a subterranean formation or contacted with a subterranean material. In another example, the composition including the enzymatic breaker and enzyme activator is injected into a subterranean formation to combine with a downhole fluid, and the combined composition is contacted with a subterranean material or is considered to be placed in the subterranean formation. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.001 wt % to about 99.999 wt %, about 0.01 wt % to about 99.99 wt %, about 0.1 wt % to about 99.9 wt %, about 20 wt % to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture including the same.

In some embodiments, the composition, or a mixture including the same, can include any suitable amount of any suitable material used in a downhole fluid. For example, the composition or a mixture including the same can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts (e.g., any suitable salt, such as potassium salts such as potassium chloride, potassium bromide, potassium formate; calcium salts such as calcium chloride, calcium bromide, calcium formate; cesium salts such as cesium chloride, cesium bromide, cesium formate, or a combination thereof), fibers, thixotropic additives, secondary breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, lime, enzyme cofactor, or a combination thereof. Any suitable proportion of the composition or mixture including the composition can include any optional component listed in this paragraph, such as about 0.001 wt % to about 99.999 wt %, about 0.01 wt % to about 99.99 wt %, about 0.1 wt % to about 99.9 wt %, about 20 to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill bit as well as reduce friction between the drill string and the sides of the hole. The drilling fluid aids in support of the drill pipe and drill bit, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the composition or a mixture including the same in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, or about 99.999 wt % or more.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ polytetrafluoroethylene), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.01 wt % to about 99.99 wt %, about 0.1 wt % to about 80 wt %, about 10 wt % to about 60 wt %, or about 0.01 wt % or less, or about 0.1 wt %, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

### Drilling Assembly.

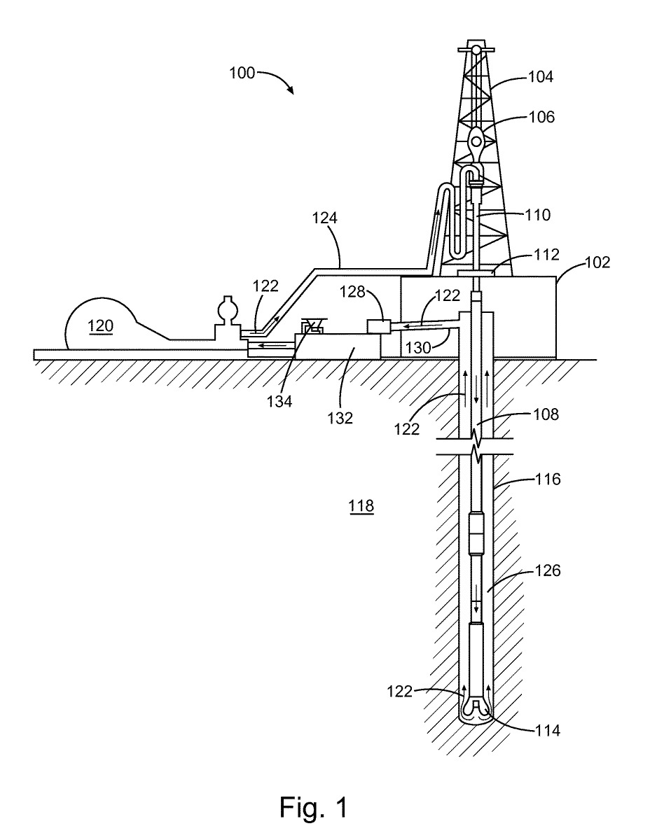

In various embodiments, the composition including the enzymatic breaker and enzyme activator disclosed herein can directly or indirectly affect one or more components or pieces of equipment associated with the preparation, delivery, recapture, recycling, reuse, and/or disposal of the disclosed composition including the enzymatic breaker and enzyme activator. For example, and with reference to FIG. 1, the disclosed composition including the enzymatic breaker and enzyme activator can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The composition including the enzymatic breaker and enzyme activator can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the composition including the enzymatic breaker and enzyme activator can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the composition including the enzymatic breaker and enzyme activator can be stored, reconditioned, and/or regulated until added to the drilling fluid 122.

As mentioned above, the composition including the enzymatic breaker and enzyme activator can directly or indirectly affect the components and equipment of the drilling assembly 100. For example, the composition including the enzymatic breaker and enzyme activator can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the composition including the enzymatic breaker and enzyme activator.

The composition including the enzymatic breaker and enzyme activator can directly or indirectly affect the pump 120, which representatively includes any conduits, pipelines, trucks, tubulars, and/or pipes used to fluidically convey the composition including the enzymatic breaker and enzyme activator to the subterranean formation; any pumps, compressors, or motors (e.g., topside or downhole) used to drive the composition into motion; any valves or related joints used to regulate the pressure or flow rate of the composition; and any sensors (e.g., pressure, temperature, flow rate, and the like), gauges, and/or combinations thereof, and the like. The composition including the enzymatic breaker and enzyme activator can also directly or indirectly affect the mixing hopper 134 and the retention pit 132 and their assorted variations.

The composition including the enzymatic breaker and enzyme activator can also directly or indirectly affect the various downhole or subterranean equipment and tools that can come into contact with the composition including the enzymatic breaker and enzyme activator such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the enzymatic breaker and enzyme activator can also directly or indirectly affect any downhole heat exchangers, valves and corresponding actuation devices, tool seals, packers and other wellbore isolation devices or components, and the like associated with the wellbore 116. The composition including the enzymatic breaker and enzyme activator can also directly or indirectly affect the drill bit 114, which can include roller cone bits, polycrystalline diamond compact (PDC) bits, natural diamond bits, hole openers, reamers, coring bits, and the like.

While not specifically illustrated herein, the composition including the enzymatic breaker and enzyme activator can also directly or indirectly affect any transport or delivery equipment used to convey the composition including the enzymatic breaker and enzyme activator to the drilling assembly 100 such as, for example, any transport vessels, conduits, pipelines, trucks, tubulars, and/or pipes used to fluidically move the composition including the enzymatic breaker and enzyme activator from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition described herein. The system can include a composition including the enzymatic breaker and enzyme activator. The system can also include a subterranean formation including the composition therein. In some embodiments, the composition in the system can also include a downhole fluid, or the system can include a mixture of the composition and downhole fluid. In some embodiments, the system can include a tubular and a pump configured to pump the composition into the subterranean formation through the tubular.

Various embodiments provide systems and apparatus configured for delivering the composition described herein to a subterranean location and for using the composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), with the tubular containing a composition including the enzymatic breaker and enzyme activator described herein.

In some embodiments, the system can include a drill string disposed in a wellbore, with the drill string including a drill bit at a downhole end of the drill string. The system can also include an annulus between the drill string and the wellbore. The system can also include a pump configured to circulate the composition through the drill string, through the drill bit, and back above-surface through the annulus. In some embodiments, the system can include a fluid processing unit configured to process the composition exiting the annulus to generate a cleaned drilling fluid for recirculation through the wellbore.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to the subterranean formation.

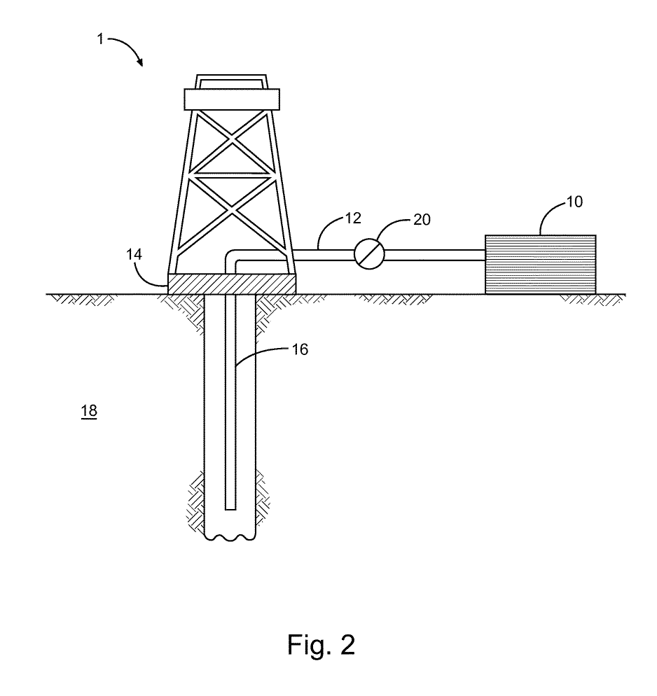

FIG. 2 shows an illustrative schematic of systems and apparatuses that can deliver embodiments of the compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can be substantially diminished in the concentration of the enzymatic breaker and enzyme activator therein. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole or subterranean equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation. The composition can be any suitable composition that can be used to perform an embodiment of the method for treatment of a subterranean formation described herein.

For example, the composition can include an enzymatic breaker and an enzyme activator including a phenyl propane unit including at least one of a) at least one hydroxy group or derivative thereof, and b) at least one sulfonic acid or a salt or ester thereof.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid.

In some embodiments, the composition can include an enzymatic breaker including at least one of hemicellulase and beta-glycosidase and at least one of a lignosulfonic acid salt and a lignin.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including an enzymatic breaker and an enzyme activator including a phenyl propane unit including at least one of a) at least one hydroxy group or derivative thereof, and b) at least one sulfonic acid or a salt or ester thereof.

30

### EXAMPLES

Various embodiments of the present invention can be better understood by reference to the following Examples which are offered by way of illustration. The present invention is not limited to the Examples given herein.

The guar fluid formations used in the Examples were 30 lbm guar gum/1000 gal, borate-crosslinked, and buffered to pH 10.5 using a carbonate buffer.

Enzyme A was hemicellulase enzyme. Enzyme B was beta-glycosidase enzyme.

LS-1, LS-3, LS-4, and LS-5 were lignosulfonic acid salts (lignosulfonates). LS-1 was a modified sodium lignosulfonate having a molecular weight in the range of 5000-8000 g/mol. LS-2 was quebracho tree bark powder from Halliburton. LS-3 was highly sulfonated ethoxylate lignin. LS-4 was a low- to mid-level sulfonation Kraft lignin sodium lignosulfonate. LS-5 was a highly sulfonated hybrid Kraft lignin sodium lignosulfonate.

Sample design and viscosity measurements. Sample fluids were designed using guar gum, a carbonate buffer, and a borate crosslinker. Additionally, a lignin-based additive and enzymatic breaker were added to the formulations. Breaker efficiency and its effect on fluid viscosity were evaluated using a Chandler® 5550 high-pressure/high-temperature (HP/HT) viscometer. Tests were conducted at 140° F. and 160° F. In a typical experiment, a specified mass of guar gum was added to water in a 1-L blender, and the polymer was allowed to hydrate for 30 minutes. Following hydration, a 250 mL aliquot was obtained and carbonate buffer, enzyme, and crosslinker (ulexite-based delayed borate crosslinker in 0.9 gptg loading, with 0.3 gptg boric acid in some cases) was added to it while the contents were being stirred in the blender. Lignosulfonate additive was added before adjusting the pH of the base gel. A 44-mL sample was placed into a Chandler 5550 viscometer equipped with a R1/B5X rotor/bob configuration. Tests were performed using a heatup profile at a 40 s⁻¹ shear rate. The rheological profile of the crosslinked gel was determined using a Chandler Model 5550 rotational viscometer.

Regain permeability measurements. All tests were performed using either Berea cores (1-in. outer diameter×2 in. length) with permeability ranging from ˜150 to 200 millidarcys (md) or Nugget cores (1-in. outer diameter ×1-in. length) with permeability ranging from 1 to 10 md. Pressure transducers were installed at the inlet and outlet of the flow-cell assembly as a means to measure the differential pressure across the core during fluid injection. Confining pressure was set to 1,000 psi, while the backpressure regulator was set to 200 psi. The cores were first saturated by flowing four pour volumes of 7% KCl brine at a flow rate of 5 cc/min (for Berea cores) and 0.5 cc/min (for Nugget cores). The cell assembly containing the saturated cores was then heated to the desired temperature. This temperature was maintained throughout the entire flow period of the experiment. At a steady flow rate of 5 cc/min (for Berea cores) and 0.5 cc/min (for Nugget cores), initial permeabilities of the cores were measured. The cores were then treated with 5 pore volumes of fluid and breaker solution. The treated volume was confirmed by measuring the amount of fluid exiting the cores. The treated cores were shut in for 24 hours at the desired temperature. After 24 hours, 7% KCl was injected into the flow cell in the reverse direction at a rate of 5 cc/min (for Berea cores) and 0.5 cc/min (for Nugget cores) to determine the final permeability or regained permeability of the cores after fluid treatment.

### Example 1

### Enzyme A

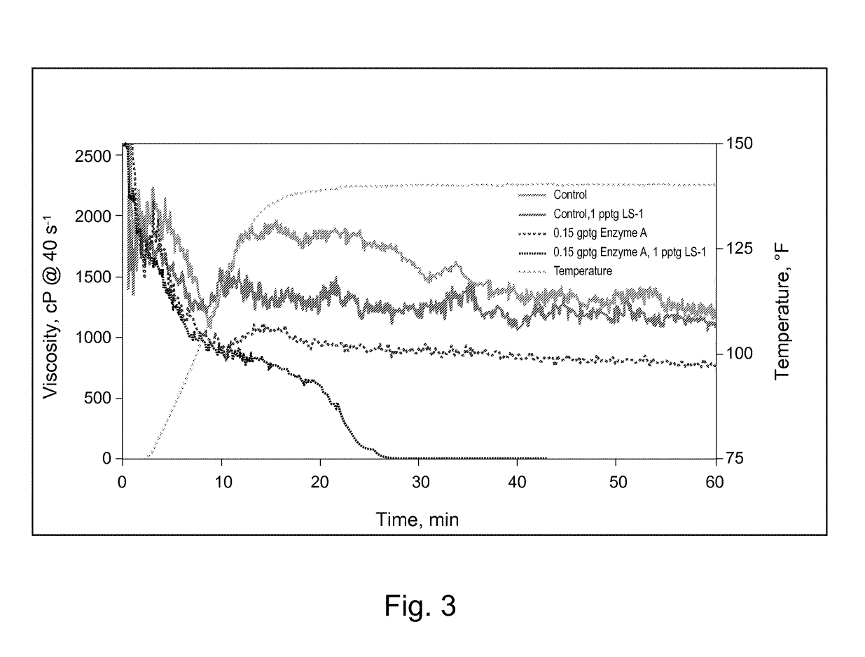

In designing fracturing treatments with enzymes, maintaining enzyme break activity at elevated pH and temperature condition is a major concern. FIG. 3 illustrates a plot of viscosity and temperature as a function of time for borate-crosslinked 30 lbm/1000 gal guar-based fluid with carbonate buffer at pH 10.5 under identical conditions of 40 s⁻¹ shear rate and heating rate. Compared to the controls using no breaker or no breaker and breaker activator, it can be seen that the viscosity of the gel formulation that contained the activated breaker package indicated a substantial decrease in the viscosity in about 25 minutes. The other formulations displayed little indication of viscosity decline over the test period.

In the first series of experiments shown in FIG. 3, it can be seen that conventional borate-crosslinked guar fluid with Enzyme A at pH 10.5 remained unbroken at 140° F. The observed enzyme inactivity could be due to denaturing of enzyme at higher pH and/or temperature. In comparison, addition of Lignosulfonate-1 (LS-1) to the same fluid formulation broke the fluid completely in approximately 26 minutes; the control test with LS-1 (without enzyme breaker) showed no effect on viscosity profile of the fluid. This suggests that since LS-1 did not contribute to polymer breaking, LS-1 might be forming a complex with Enzyme A, enabling it to be more stable at elevated pH and temperature than Enzyme A by itself.

### Example 2

### Other Enzymes and Delayed Breaking

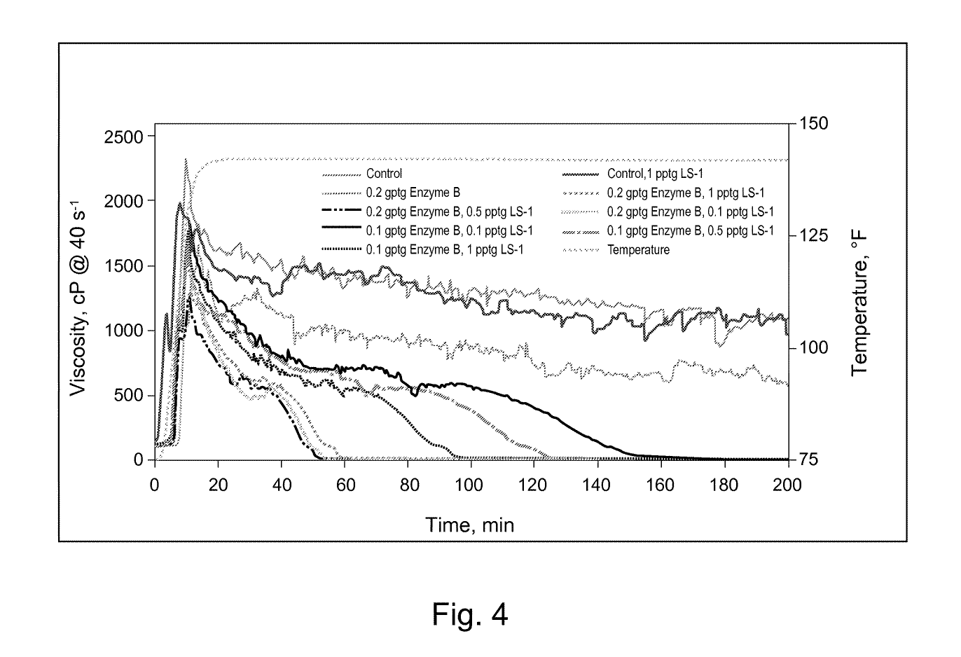

To further determine if LS-1 was able to activate other enzymes, another enzyme (Enzyme B) was evaluated. In addition, the effect of modulating activator concentration was investigated, to ascertain other potentially positive outcomes of using the lignosulfonate-based activator. FIG. 4 illustrates viscosity and temperature as a function of time for borate-crosslinked 30 lbm/1000 gal of guar-based fluid at pH 10.5 under identical conditions of 40 s⁻¹ shear rate and heating rate. FIG. 4 shows that Enzyme B in combination with LS-1 broke the fluid completely. Moreover, twice the concentration Enzyme B was ineffective in breaking the fluid at pH 10.5 at 140° F. In general, controlling break times of fracturing fluids can be challenging. Usually, customizable break times are obtained by varying the concentration of breaker. For example, if faster break time is needed, then a higher breaker amount is added to the fluid; however, the use of higher amounts for a faster fluid break can add significant cost to the fluid design. Conversely, if a lesser amount of enzyme is used, extended break times are achievable, but incomplete polymer breakdown may result, potentially leading to greater formation damage, lower proppant pack permeability, and underperforming reservoir conductivity. Maintaining the economics of well construction is of utmost concern for many operators, and increasing the performance of fracturing fluids while maintaining the cost can be beneficial. This study shows that by varying the amount of lignosulfonate additive and keeping the enzyme loading constant, (FIG. 4 and Table 1) the break times of guar-based fluids can be modulated. The higher loading of the inexpensive lignosulfonate aids in faster breaking of the fluid. Consequently, this approach is more economical as it requires lower enzyme loading. By using the lignosulfonate activator, the polymer breakdown is complete in spite of low amounts of the enzyme used. This potentially leads to more complete fracturing fluid hydrolysis, better regained permeability, and better reservoir productivity.

TABLE 1
Summary of different formulations with time required to
reach fluid viscosity below 200 cP.

| | Time Required | |
|---|---|---|
| | to Reach | |
| | Fluid Viscosity | |
| Breaker Package | Below 200 cP | |
| Control | >200 | min |
| 1 lbm/1000 gal LS-1 | >200 | min |
| 0.2 gal/1000 gal Enzyme B | >200 | min |
| 0.1 lbm/1000 gal LS-1, 0.1 gal/1000 gal Enzyme B | 135 | min. |
| 0.5 lbm/1000 gal LS-1, 0.1 gal/1000 gal Enzyme B | 110 | min. |
| 1.0 lbm/1000 gal LS-1, 0.1 gal/1000 gal Enzyme B | 84 | min. |
| 0.1 lbm/1000 gal LS-1, 0.2 gal/1000 gal Enzyme B | 47 | min. |

### Example 3

### Preformulated Mixture

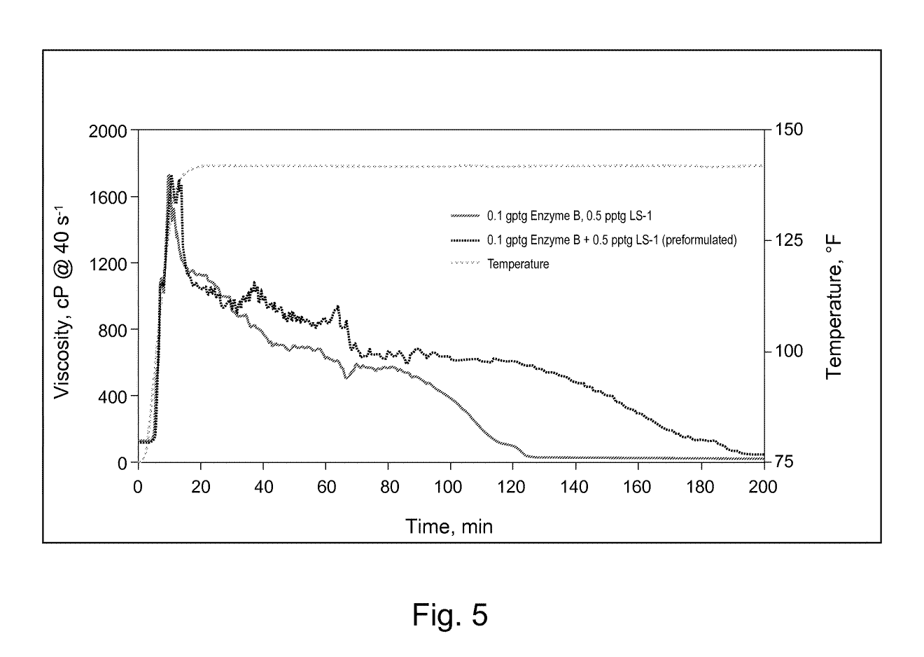

In designing chemicals for field use, it can be important to reduce the complexity of chemical delivery at the wellsite. To eliminate addition of enzyme and lignosulfonate separately, performance of a preformulated mixture of Enzyme B and LS-1 was evaluated. The desired amounts of Enzyme B and LS-1 were mixed and this mixture was stored at 0° C. for one week before using it as a breaker package. The preformulated mixture broke the fluid; however, it required longer time (<50 cP after 195 min.) compared to the non-formulated counterpart (<50 cP after 124 min). These results are shown in FIG. 5. FIG. 5 illustrates viscosity and temperature as a function of time for borate-crosslinked 30 lbm/1000 gal of guar-based fluid with Enzyme B and LS-1 added separately vs. preformulated mixture of Enzyme B and LS-1 at pH 10.5 under identical conditions of 40 s⁻¹ shear rate and heating rate. The preformulation approach may be preferred in the field as it can reduce the complexity of mixing two chemicals during the hydraulic fracturing operation, as well as reduce the logistical complications of having multiple chemicals at the well site.

### Example 4

### Other Lignosulfonates

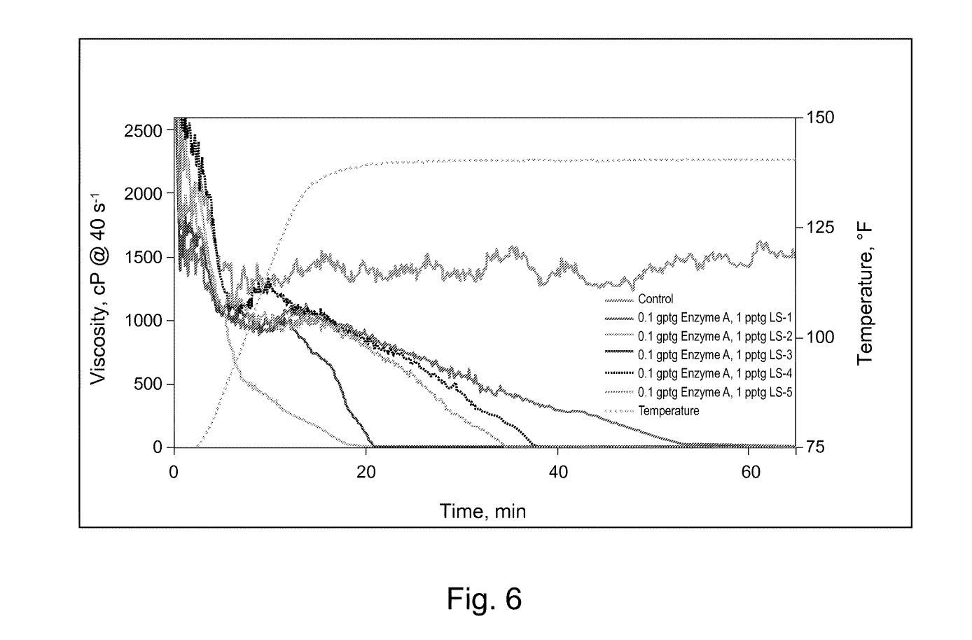

Enzymes bind specifically to different molecules and this interaction alters their structure and activity. To evaluate if the enzyme activation was specific to a particular lignosulfonate, four additional lignosulfonate analogues were evaluated. FIG. 6 illustrates a plot of viscosity and temperature as a function of time for borate-crosslinked 30 lbm/1000 gal guar-based fluid with Enzyme A and different lignosulfonates (LS-1 to LS-5) at pH 10.5 under identical conditions of 40 s⁻¹ shear rate and heating rate.

FIG. 6 shows that all five lignosulfonates (LS-1 to LS-5) were effective in breaking the borate-crosslinked guar gel. Different lignosulfonates yielded variable gel break times. All the lignosulfonates chosen were structurally different (molecular weight, propoprtion and location of various functional groups, etc.) and therefore their effective binding to the enzyme sites could differ. Based on the data obtained from this study it can be inferred that the variance in gel break time can be attributed to different lignosulfonates' ability to activate the enzyme in some manner

### Example 5

### 160° F. and pH 10.5.

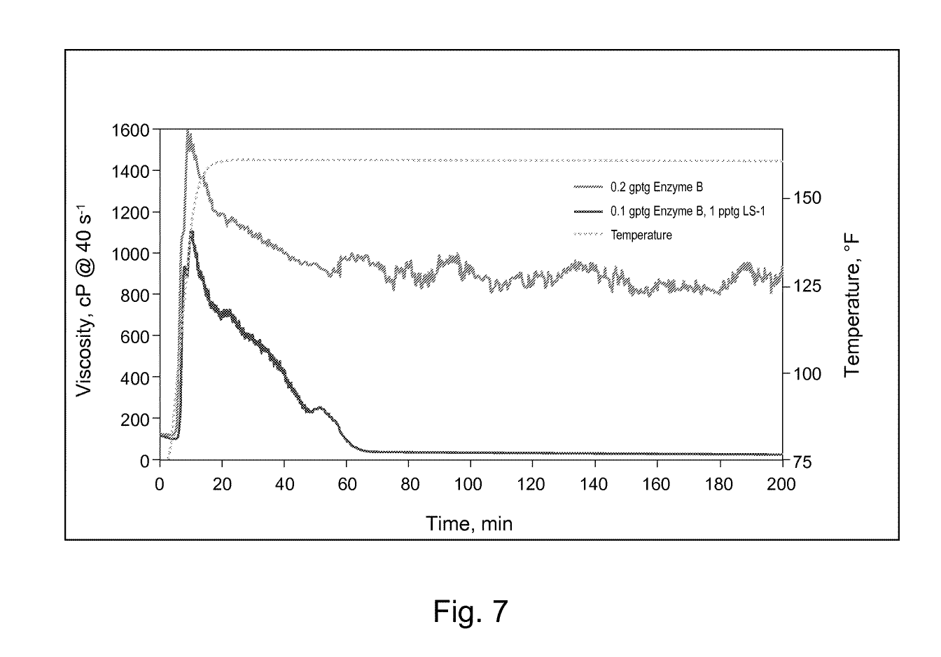

To determine if the addition of lignosulfonate as an enzyme activator was possible, the 30 lbm/1000 gal guar/borate fluid formulation using LS-1 as an enzyme activator was challenged at 160° F. and pH 10.5. FIG. 7 illustrates a plot of viscosity and temperature as a function of time for borate-crosslinked 30 lbm/1000 gal of guar-based fluid with Enzyme B alone vs. Enzyme B and LS-1 as a breaker at 160° F. Identical conditions of 40 s⁻¹ shear rate and heating rate were used. FIG. 7 shows that LS-1 was effective in maintaining the enzyme breaker activity at elevated temperature. Moreover, Enzyme B in the absence of LS-1 did not break guar fluid even after 3 hours.

### Example 6

### Regained Permeability

Results of regained core permeability were compared for the guar-based fluid with Enzyme A and B in presence and absence of LS-1 additive. The tests were performed with Berea cores with permeability of 50-150 mD. Table 2 summarizes regained permeability results for Enzyme A with and without addition of LS-1 at 140° F. and 160° F. At both the temperatures tested, higher regained permeability was observed when LS-1 was added to the fluid. At 140° F., the difference in regained permeability with and without LS-1 was 5%. However, at 160° F., the regained permeability difference with and without LS-1 was 8.6%. The enhanced clean-up (8.6% vs. 5% regain permeability difference) at 160° F. compared to 140° F. is attributed to lignosulfonates' ability to retain enzyme breaker activity at elevated temperature.

TABLE 2
Regain permeability results for breaker package with
Enzyme A at 140° F. and 160° F. (Berea cores;
permeability 50-150 mD).

| | Tempera- | Initial | Final | Regained |
|---|---|---|---|---|
| | ture | Permeability | Permeability | Permeability |
| | (° F.) | (mD) | (mD) | (%) |
| 0.15 gptg | 140° F. | 71.7 | 55.7 | 77.7 |
| Enzyme A | | | | |
| 0.15 gptg Enzyme | 140° F. | 87.1 | 72.1 | 82.7 |
| A, 1 lbm/1000 gal | | | | |
| LS-1 | | | | |
| 0.20 gptg | 160° F. | 64.6 | 42.5 | 65.7 |
| Enzyme A | | | | |
| 0.20 gptg Enzyme | 160° F. | 79.9 | 59.4 | 74.3 |
| A, 1 lbm/1000 gal | | | | |
| LS-1 | | | | |

In general, low-permeability rocks are more sensitive to reduction in permeability due to inefficient gel breaking as compared to high-permeability rocks. Consequently, another set of regained permeability tests were performed using lower permeability cores at 140° F. In these tests, Nugget cores with permeability of 1-10 mD were used. Table 3 shows regained permeabilities for three borate-crosslinked guar fluid formulations at pH 10.5 with: (1) Enzyme B, (2) Enzyme B +1 lbm/1000 gal LS-1, and (3) Enzyme B+5 lbm/1000 gal LS-1. As the data illustrates, there was substantial core damage when Enzyme B alone was used as a breaker. The core damage was reduced by some extent when 1 lbm/1000 gal LS-1 was added in combination with Enzyme B. An approximately 6 fold increase in regain permeability was obtained when 5 lbm/1000 gal LS-1 was added along with Enzyme B. This substantial increase in regained permeability clearly demonstrates that lignin-based additives are effective in enhancing the breaker activity of the enzymes.

TABLE 3
Regain permeability results for breaker package with
Enzyme B at 140° F. (nugget cores; permeability 1-10 mD).

| | Tempera- | Initial | Final | Regained |
|---|---|---|---|---|
| | ture | Permeability | Permeability | Permeability |
| | (° F.) | (md) | (md) | (%) |
| 0.20 gptg | 140° F. | 5.56 | 0.36 | 6.5 |
| Enzyme B | | | | |
| 0.20 gptg Enzyme | 140° F. | 1.82 | 0.20 | 11.2 |
| B, 1 lbm/1000 gal | | | | |
| LS-1 | | | | |
| 0.20 gptg Enzyme | 140° F. | 1.03 | 0.43 | 41.3 |
| B, 5 lbm/1000 gal | | | | |
| LS-1 | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:
placing in a subterranean formation a composition comprising
   an enzymatic breaker; and
   an enzyme activator comprising a phenyl propane unit comprising at least one of a) at least one hydroxy group or derivative thereof, and b) at least one sulfonic acid or a salt or ester thereof.

Embodiment 2 provides the method of Embodiment 1, wherein the method further comprises obtaining or providing the composition, wherein the obtaining or providing of the composition occurs above-surface.

Embodiment 3 provides the method of any one of Embodiments 1-2, wherein the method further comprises obtaining or providing the composition, wherein the obtaining or providing of the composition occurs in the subterranean formation.

Embodiment 4 provides the method of any one of Embodiments 1-3, further comprising combining the composition with a viscosifier solution in the subterranean formation.

Embodiment 5 provides the method of any one of Embodiments 1-4, further comprising breaking a viscosified solution in the subterranean formation using the composition.

Embodiment 6 provides the method of any one of Embodiments 1-5, wherein the composition comprises a viscosified solution.

Embodiment 7 provides the method of any one of Embodiments 1-6, wherein the method comprises fracturing the subterranean formation.

Embodiment 8 provides the method of any one of Embodiments 1-7, wherein the composition further comprises an aqueous carrier fluid.

Embodiment 9 provides the method of any one of Embodiments 1-8, wherein a borate-crosslinked guar solution comprising about 0.15 gptg of the enzymatic breaker and about 1 pptg of the enzyme activator under conditions comprising about 30 minutes at about 100° F. to about 400° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

Embodiment 10 provides the method of any one of Embodiments 1-9, wherein a borate-crosslinked guar solution comprising about 0.15 gptg of the enzymatic breaker and about 1 pptg of the enzyme activator under conditions comprising about 30 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

Embodiment 11 provides the method of any one of Embodiments 1-10, wherein a borate-crosslinked guar solution comprising about 0.15 gptg of the enzymatic breaker and about 1 pptg of the enzyme activator under conditions comprising about 30 minutes at about 140° F. to 160° F. and a shear rate of 40 s⁻¹ with a pH of about 2 to about 14 has a viscosity of less than about 200 cP, wherein a corresponding borate-crosslinked guar solution that is free of the enzyme activator has a viscosity of about 500 cP to about 2000 cP under the same conditions.

Embodiment 12 provides the method of any one of Embodiments 1-11, wherein a borate-crosslinked guar solution comprising about 0.1 gptg of the enzymatic breaker and about 0.1 pptg of the enzyme activator under conditions comprising about 100 minutes at about 140° F. to about 160° F. and a shear rate of 40 s⁻¹ with a pH of 10.5 has a viscosity of greater than about 500 cP, and under conditions comprising about 140 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

Embodiment 13 provides the method of any one of Embodiments 1-12, wherein a borate-crosslinked guar solution comprising about 0.1 gptg of the enzymatic breaker and about 0.5 pptg of the enzyme activator under conditions comprising about 80 minutes at about 140° F. to about 160° F. and a shear rate of 40 s⁻¹ with a pH of 10.5 has a viscosity of greater than about 500 cP, and under conditions comprising about 120 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

Embodiment 14 provides the method of any one of Embodiments 1-13, wherein a borate-crosslinked guar solution comprising about 0.1 gptg of the enzymatic breaker and about 0.1 pptg of the enzyme activator under conditions comprising about 60 minutes at about 140° F. to about 160° F. and a shear rate of 40 s⁻¹ with a pH of 10.5 has a viscosity of greater than about 500 cP, and under conditions comprising about 100 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2000 cP under the same conditions.

Embodiment 15 provides the method of any one of Embodiments 1-14, wherein a borate-crosslinked guar solution comprising about 0.15 gptg to about 0.2 gptg of the enzymatic breaker and about 1 pptg of the enzyme activator under conditions comprising about 60 minutes at about 140° F. to about 160° F. provides a percent regain permeability in a core having an initial permeability of about 1 md to about 150 md that is about 1% to about 20% higher than the percent regain permeability of a corresponding borate-crosslinked guar solution that is free of the enzyme activator.

Embodiment 16 provides the method of any one of Embodiments 1-15, wherein a borate-crosslinked guar solution comprising about 0.15 gptg to about 0.2 gptg of the enzymatic breaker and about 1 pptg of the enzyme activator under conditions comprising about 60 minutes at about 140° F. to about 160° F. provides a percent regain permeability in a core having an initial permeability of about 5 md to about 90 md that is about 4% to about 10% higher than the percent regain permeability of a corresponding borate-crosslinked guar solution that is free of the enzyme activator.

Embodiment 17 provides the method of any one of Embodiments 1-16, wherein about 0.001 gptg to about 999 gptg of the composition is the enzymatic breaker.

Embodiment 18 provides the method of any one of Embodiments 1-17, wherein about 0.01 gptg to about 1 gptg of the composition is the enzymatic breaker.

Embodiment 19 provides the method of any one of Embodiments 1-18, wherein the enzymatic breaker is at least one of an alpha or beta amylase, amyloglucosidase, oligoglucosidase, invertase, maltase, mannanase, galactomannanase, glycocidase, cellulase, hemi-cellulase, and mannanohydrolase.

Embodiment 20 provides the method of any one of Embodiments 1-19, wherein the enzymatic breaker is at least one of a deaminase, a dehydrogenase, an oxidase, a reductase, a phosphorylase, an aldolase, a synthetase, a hydrolase, and a hydroxyethylphosphonate dioxygenase.

Embodiment 21 provides the method of any one of Embodiments 1-20, wherein the enzymatic breaker is at least one of a hemicellulase, a mannanase, a xylanase, and a glycosidase.

Embodiment 22 provides the method of any one of Embodiments 1-21, wherein the enzymatic breaker is at least one of beta-glycosidase, beta-D-mannoside mannohydrolase, and mannan endo-1,4-beta-mannosidase.

Embodiment 23 provides the method of any one of Embodiments 1-22, wherein about 0.001 pptg to about 8339 pptg of the composition is the enzyme activator.

Embodiment 24 provides the method of any one of Embodiments 1-23, wherein about 0.01 pptg to about 5 pptg of the composition is the enzyme activator.

Embodiment 25 provides the method of any one of Embodiments 1-24, wherein the enzyme activator is a lignosulfonic acid or a salt or ester thereof.

Embodiment 26 provides the method of any one of Embodiments 1-25, wherein the sulfonic acid of the enzyme activator is in the form of a salt.

Embodiment 27 provides the method of any one of Embodiments 1-26, wherein the sulfonic acid of the enzyme activator is in the form of a sulfonic acid salt, wherein at each occurrence the salt has a counterion that is independently chosen from Na⁺, K⁺, Li⁺, Zn⁺, NH₄⁺, Fe²⁺, Fe³⁺, Cu¹⁺, C²⁺, Ca²⁺, Mg²⁺, Zn²⁺, and Al³⁺.

Embodiment 28 provides the method of any one of Embodiments 1-27, wherein the enzyme activator is a lignosulfonic acid salt.

Embodiment 29 provides the method of any one of Embodiments 1-28, wherein the enzyme activator is a sulfonated Kraft lignin.

Embodiment 30 provides the method of any one of Embodiments 1-29, wherein the enzyme activator is a lignosulfonic acid salt prepared via the Howard process.

Embodiment 31 provides the method of any one of Embodiments 1-30, wherein the enzyme activator has a molecular weight of about 1,000 g/mol to about 500,000 g/mol.

Embodiment 32 provides the method of any one of Embodiments 1-31, wherein the enzyme activator has a molecular weight of about 5,000 g/mol to about 50,000 g/mol.

Embodiment 33 provides the method of any one of Embodiments 1-32, wherein the phenyl propane unit is a repeating unit having the structure:

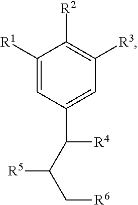

wherein
at each occurrence R¹, R³, R⁴, and R⁵ are each independently chosen from —H, R², and R⁶,
at each occurrence R² and R⁶ are each independently chosen from OH, —OCH₃, —O-Q, -Q, and —S(O)(O)(OH) or a salt or (C₁-C₅)alkyl ester thereof, and
at each occurrence Q is independently chosen from the same or different phenyl propane repeating unit bound via position R¹, R², R³, R⁴, R⁵, or R⁶, and a different repeating unit.

Embodiment 34 provides the method of Embodiment 33, wherein the enzyme activator has at least some phenyl propane repeating units with R⁴ of —S(O)(O)(OH) or a salt or (C₁-C₅)alkyl ester thereof.

Embodiment 35 provides the method of any one of Embodiments 33-34, wherein the enzyme activator has at least some phenyl propane repeating units with R⁴ of —S(O)(O)(OH) or a salt or (C₁-C₅)alkyl ester thereof.

Embodiment 36 provides the method of any one of Embodiments 1-35, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof, to form a mixture, wherein the placing the composition in the subterranean formation comprises placing the mixture in the subterranean formation.

Embodiment 37 provides the method of any one of Embodiments 1-36, wherein at least one of prior to, during, and after the placing of the composition in the subterranean formation, the composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof.

Embodiment 38 provides the method of any one of Embodiments 1-37, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, secondary breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, enzyme cofactor, or a combination thereof.

Embodiment 39 provides the method of any one of Embodiments 1-38, wherein the placing of the composition in the subterranean formation comprises fracturing at least part of the subterranean formation to form at least one subterranean fracture.

Embodiment 40 provides the method of any one of Embodiments 1-39, wherein the composition further comprises a proppant, a resin-coated proppant, or a combination thereof.

Embodiment 41 provides the method of any one of Embodiments 1-40, wherein the placing of the composition in the subterranean formation comprises pumping the composition through a tubular disposed in a wellbore and into the subterranean formation.

Embodiment 42 provides the method of any one of Embodiments 1-41, wherein the placing of the composition in the subterranean formation comprises pumping the composition through a drill string disposed in a wellbore, through a drill bit at a downhole end of the drill string, and back above-surface through an annulus.

Embodiment 43 provides the method of Embodiment 42, further comprising processing the composition exiting the annulus with at least one fluid processing unit to generate a cleaned composition and recirculating the cleaned composition through the wellbore.

Embodiment 44 provides a system for performing the method of any one of Embodiments 1-43, the system comprising:
a tubular disposed in the subterranean formation; and
a pump configured to pump the composition in the subterranean formation through the tubular.

Embodiment 45 provides a system for performing the method of any one of Embodiments 1-43, the system comprising:
a drill string disposed in a wellbore, the drill string comprising a drill bit at a downhole end of the drill string;
an annulus between the drill string and the wellbore; and
a pump configured to circulate the composition through the drill string, through the drill bit, and back above-surface through the annulus.

Embodiment 46 provides a method of treating a subterranean formation, the method comprising:
placing in a subterranean formation a composition comprising
   an enzymatic breaker comprising at least one of hemicellulase and beta-glycosidase; and
   at least one of a lignin and a lignosulfonic acid salt.

Embodiment 47 provides a system comprising:
a composition comprising
   an enzymatic breaker; and
   an enzyme activator comprising a phenyl propane unit comprising at least one of a) at least one hydroxy group or derivative thereof, and b) at least one sulfonic acid or a salt or ester thereof; and
a subterranean formation comprising the composition therein.

Embodiment 48 provides the system of Embodiment 47, further comprising
a drill string disposed in a wellbore, the drill string comprising a drill bit at a downhole end of the drill string;
an annulus between the drill string and the wellbore; and
a pump configured to circulate the composition through the drill string, through the drill bit, and back above-surface through the annulus.

Embodiment 49 provides the system of Embodiment 48, further comprising a fluid processing unit configured to process the composition exiting the annulus to generate a cleaned drilling fluid for recirculation through the wellbore.

Embodiment 50 provides the system of any one of Embodiments 47-49, further comprising
a tubular disposed in the subterranean formation; and
a pump configured to pump the composition in the subterranean formation through the tubular.

Embodiment 51 provides a composition for treatment of a subterranean formation, the composition comprising:
an enzymatic breaker; and
an enzyme activator comprising at least one of a) at least one hydroxy group or derivative thereof, and b) at least one sulfonic acid or a salt or ester thereof.

Embodiment 52 provides the composition of Embodiment 51, wherein the composition further comprises a downhole fluid.

Embodiment 53 provides a composition for treatment of a subterranean formation, the composition comprising:
an enzymatic breaker comprising at least one of hemicellulase and beta-glycosidase; and
at least one of a lignosulfonic acid salt and a lignin.

Embodiment 54 provides a method of preparing a composition for treatment of a subterranean formation, the method comprising:
forming a composition comprising
   an enzymatic breaker; and
   an enzyme activator comprising at least one of a) at least one hydroxy group or derivative thereof, and b) at least one sulfonic acid or a salt or ester thereof.

Embodiment 55 provides the composition, apparatus, method, or system of any one or any combination of Embodiments 1-54 optionally configured such that all elements or options recited are available to use or select from.

1.-54. (canceled)

55. A method of treating a subterranean formation, comprising:
placing a composition into the subterranean formation, wherein the composition comprises:
an enzymatic breaker; and
an enzyme activator comprising a phenyl propane unit, wherein the phenyl propane unit comprises a hydroxy, a sulfonic acid, a sulfonic acid salt, a sulfonic acid ester, or combinations thereof.

56. The method of claim 55, wherein the enzymatic breaker comprises at least one of an alpha or beta amylase, amyloglucosidase, oligoglucosidase, invertase, maltase, mannanase, galactomannanase, glycocidase, cellulase, hemi-cellulase, mannanohydrolase, or any combination thereof.

57. The method of claim 55, wherein the enzymatic breaker comprises at least one of a deaminase, a dehydrogenase, an oxidase, a reductase, a phosphorylase, an aldolase, a synthetase, a hydrolase, a hydroxyethylphosphonate dioxygenase, or any combination thereof.

58. The method of claim 55, wherein the enzymatic breaker comprises at least one of beta-glycosidase, beta-D-mannoside mannohydrolase, mannan endo-1,4-beta-mannosidase, or any combination thereof.

59. The method of claim 55, wherein the enzymatic breaker comprises hemicellulose, beta-glycosidase, or a combination thereof, and wherein the enzyme activator comprises a lignosulfonic acid salt.

60. The method of claim 55, wherein the enzymatic breaker comprises at least one of a hemicellulase, a mannanase, a xylanase, a glycosidase, or any combination thereof, and wherein the enzymatic breaker comprises about 0.01 gptg to about 1 gptg of the composition.

61. The method of claim 60, wherein the enzyme activator comprises a lignosulfonic acid or a salt or ester thereof, and wherein the enzyme activator comprises about 0.01 pptg to about 5 pptg of the composition.

62. The method of claim 55, wherein the enzyme activator comprises the sulfonic acid salt, and wherein the sulfonic acid salt comprises a counterion selected from the group consisting of Na⁺, K⁺, Li⁺, Zn⁺, NH₄⁺, Fe²⁺, Fe³⁺, Cu¹⁺, Cu²⁺, Ca²⁺, Mg²⁺, Zn²⁺, Al³⁺, and combinations thereof.

63. The method of claim 55, wherein the enzyme activator comprises a sulfonated kraft lignin, a lignosulfonic acid salt prepared via the Howard process, or a combination thereof.

64. The method of claim 55, wherein the enzyme activator has a molecular weight of about 5,000 g/mol to about 50,000 g/mol.

65. The method of claim 55, wherein the phenyl propane unit is a repeating unit having the structure: 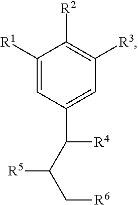
wherein:
each R¹, R³, R⁴, and R⁵ is independently selected from the group consisting of H, R², and R⁶;
each R² and R⁶ is independently selected from the group consisting of —OH, —OCH₃, —O-Q, -Q, and —S(O)(O)(OH) or a salt or (C₁-C₅)alkyl ester thereof; and
each occurrence of Q is independently chosen from the same or different phenyl propane repeating unit bound via R¹, R², R³, R⁴, R⁵, or R⁶, or a different repeating unit.

66. The method of claim 65, wherein the enzyme activator comprises phenyl propane repeating units where at least one of R¹, R², or R³ is —S(O)(O)(OH) or a salt or (C₁-C₅)alkyl ester thereof.

67. The method of claim 65, wherein the enzyme activator comprises phenyl propane repeating units where R⁴ is —S(O)(O)(OH) or a salt or (C₁-C₅)alkyl ester thereof.

68. The method of claim 55, wherein a borate-crosslinked guar solution comprising about 0.15 gptg of the enzymatic breaker and about 1 pptg of the enzyme activator under conditions comprising about 30 minutes at about 140° F. to about 160° F. and a shear rate of 40 s⁻¹ with a pH of 10.5 has a viscosity of less than about 200 cP, wherein a corresponding borate-crosslinked guar solution that is free of the enzyme activator has a viscosity of about 500 cP to about 2,000 cP under the same conditions.

69. The method of claim 55, wherein the composition further comprises a proppant, and wherein the method further comprises fracturing at least part of the subterranean formation to form a subterranean fracture.

70. The method of claim 55, wherein placing the composition in the subterranean formation comprises pumping the composition through a drill string disposed in a wellbore, through a drill bit at a downhole end of the drill string, and back above-surface through an annulus.

71. The method of claim 70, further comprising processing the composition exiting the annulus with a fluid processing unit to generate a cleaned composition and recirculating the cleaned composition through the wellbore.

72. A system for performing the method of claim 55, the system comprising:
a drill string disposed in a wellbore, the drill string comprising a drill bit at a downhole end of the drill string, and in the subterranean formation comprises the wellbore;
an annulus between the drill string and the wellbore; and
a pump configured to circulate the composition through the drill string, through the drill bit, and back above-surface through the annulus.

73. A method of treating a subterranean formation, comprising:
placing a composition into the subterranean formation, wherein the composition comprises:
an enzymatic breaker comprising hemicellulose, beta-glycosidase, or a combination thereof; and
an enzyme activator comprising a phenyl propane unit, wherein the phenyl propane unit comprises a hydroxy, a sulfonic acid, a sulfonic acid salt, a sulfonic acid ester, or combinations thereof.

74. A composition for treatment of a subterranean formation, comprising:
an enzymatic breaker comprising at least one of hemicellulase and beta-glycosidase; and
a lignosulfonic acid salt.
